(19) United States
(12) Patent Application Publication
(10) Pub. No.: US 2026/0351041 A1
(43) Pub. Date: Nov. 5, 2026

(54) SKIN RETOUCHING AND FACIAL FEATURE ADJUSTMENT METHOD, APPARATUS, COMPUTER DEVICE, AND MEDIUM

(71) Applicant: SHENZHEN HOLLYLAND TECHNOLOGY CO., LTD., Shenzhen, Guangdong (CN)

(72) Inventors: Dezhi LIU, Shenzhen, Guangdong (CN); Qixun CHEN, Shenzhen, Guangdong (CN)

(73) Assignee: SHENZHEN HOLLYLAND TECHNOLOGY CO., LTD., Shenzhen, Guangdong (CN)

(21) Appl. No.: 19/488,624

(22) PCT Filed: Nov. 23, 2023
(86) PCT No.: PCT/CN2023/133519

§ 371 Date: Nov. 27, 2025

(51) Int. Cl. G06V 40/16; G06N 3/0464; G06T 3/40; G06T 7/10; G06V 10/25; G06V 10/82

(52) U.S. Cl. CPC G06V 40/171; G06N 3/0464; G06T 3/40; G06T 7/10; G06V 10/25; G06V 10/82; G06V 40/161

(57) ABSTRACT

The present invention provides a skin retouching and facial feature adjustment method and apparatus, a computer device, and a medium. The method comprises: obtaining a target image; identifying an upper body bounding box and a face bounding box of a target person in the target image; performing skin segmentation on an image area of the upper body bounding box, so as to perform skin retouching; and identifying a plurality of face key points in an image area of the face bounding box, so as to perform facial feature adjustment. According to the method, an upper body bounding box and a face bounding box of a target person in a target image are identified, and the image area of the upper body bounding box comprises a face skin area and other skin areas of the upper body, so as to achieve natural transition between the face skin area and the other skin areas of the upper body after skin retouching, thereby improving the visual effect; moreover, the image area of the face bounding box only comprises a face area, so that the noise when identifying face key points in the image area of the face bounding box is greatly reduced, thereby improving the detection accuracy and precision.

### TECHNICAL FIELD

The present disclosure relates to the field of image processing, and in particular, to a skin retouching and facial feature adjustment method, apparatus, computer device, and medium.

### BACKGROUND

Nowadays, in live streaming, short videos, and social software, it is necessary to provide skin retouching and facial feature adjustment functions to meet the needs of users, skin retouching mainly refers to the processing such as skin whitening and skin smoothing, and facial feature adjustment refers to the processing such as face thinning and eye enlargement.

In the related art, a skin retouching and facial feature adjustment algorithm is generally used to recognize a face bounding box of each person in an image, extract a skin region, and perform landmark detection on an image region of the face bounding box, and then perform skin retouching and facial feature adjustment processing.

However, the image region of the face bounding box can only extract the skin region of the face, and cannot extract other skin regions in the image, which results in the obvious difference between the facial skin region and other skin regions after the skin retouching and facial feature adjustment processing, leading to poor viewing experience. Moreover, if the image region of the face bounding box includes a region other than the face (e.g., a neck region), it results in excessive noise when recognizing facial landmarks, leading to low detection precision.

### SUMMARY

In view of this, embodiments of the present disclosure provide a skin retouching and facial feature adjustment method, apparatus, computer device, and medium, so as to solve the technical problems in the related art.

According to a first aspect of embodiments of the present disclosure, there is provided a skin retouching and facial feature adjustment, including:
acquiring a target image;
recognizing an upper body bounding box and a face bounding box of a target person in the target image;
performing skin segmentation on an image region of the upper body bounding box to perform skin retouching processing; and
recognizing a plurality of facial landmarks in an image region of the face bounding box to perform facial feature adjustment processing.

In some embodiments, a quantity of the facial landmarks is 106, 98 of the facial landmarks are standard landmarks, and 8 of the facial landmarks are customized landmarks in a region of a nose.

In some embodiments, the customized landmarks are symmetrically distributed on left and right sides of the nose, and each customized landmark is intersected with a boundary of the nose through a horizontal line on the nose.

In some embodiments, skin segmentation on the image region of the upper body bounding box is performed by a first neural network; recognizing the plurality of facial landmarks in the image region of the face bounding box is performed by a second neural network; and the first neural network and the second neural network are lightweight neural networks.

In some embodiments, a device performing the method is deployed with DSP, GPU, NPU, and CPU, and the method further includes:
performing, through the DSP, skin segmentation on the image region of the upper body bounding box;
performing, through the GPU, skin retouching processing and performing facial feature adjustment processing;
recognizing the upper body bounding box and the face bounding box of the target person in the target image includes:
preprocessing, through the DSP, the target image;
recognizing, through the NPU, a plurality of candidate upper body bounding boxes and a plurality of candidate face bounding boxes of the target person from the preprocessed target image based on a target detection model; and
determining, through the CPU, the upper body bounding box and the face bounding box from the plurality of candidate upper body bounding boxes and the plurality of candidate face bounding boxes; and
recognizing the plurality of facial landmarks in the image region of the face bounding box includes:
preprocessing, through the GPU, the image region of the face bounding box;
recognizing, by the second neural network through the NPU, a plurality of candidate facial landmarks of the preprocessed target image; and
determining, through the CPU, the plurality of facial landmarks from the plurality of candidate facial landmarks.

In some embodiments, the target detection model is an improved YOLOv7 model, a head network of the improved YOLOv7 model includes a feature fusion module, and the feature fusion module is configured to perform, on a low-resolution feature map, enlarging receptive fields, upsampling, and channel-number transformation, and fuse the processed low-resolution feature map with a high-resolution feature map.

According to a second aspect of embodiments of the present disclosure, there is provided a skin retouching and facial feature adjustment apparatus, including:
an image acquisition module configured to: acquire a target image;
an image recognition module configured to: recognize an upper body bounding box and a face bounding box of a target person in a target image;
a skin segmentation module configured to: perform skin segmentation on an image region of the upper body bounding box to perform skin retouching processing; and
a landmark detection module configured to: recognize a plurality of facial landmarks in an image region of the face bounding box to perform facial feature adjustment processing.

In some embodiments, a quantity of the facial landmarks is 106, 98 of the facial landmarks are standard landmarks, and 8 of the facial landmarks are customized landmarks located in a region of a nose; and the customized landmarks are symmetrically distributed on left and right sides of the nose, and each customized landmark is intersected with a boundary of the nose through a horizontal line on the nose.

According to a third aspect of embodiments of the present disclosure, there is provided a computer device, including at least one processor and a machine-readable storage medium, where the machine-readable storage medium stores machine-executable instructions executable by the at least one processor, and the at least one processor is enabled by the machine-executable instructions to perform the method according to the above first aspect.

According to a fourth aspect of embodiments of the present disclosure, a computer-readable storage medium is provided, where the medium stores a computer program, and the computer program, when executed by at least one processor, implements the method the method according to the above first aspect.

It can be seen from the above technical solutions that, in the technical solutions of the present disclosure, the upper body bounding box and the face bounding box of the target person in the target image are recognized, and the image region of the upper body bounding box includes the facial skin region and other skin regions of the upper body, such that the facial skin region and other skin regions of the upper body are transitionally natural after the skin retouching, which improves the viewing experience, and the image region of the face bounding box only includes the face region, which greatly reduces the noise when recognizing facial landmarks in the image region of the face bounding box, and improves the detection accuracy and precision.

### BRIEF DESCRIPTION OF DRAWINGS

In order to clearly illustrate the technical solution of the embodiments of the disclosure, the drawings that need to be used in the description of the embodiments will be briefly introduced below, and it is obvious that the drawings in the following description are only some embodiments of the present disclosure, and other drawings may further be obtained from these drawings without making creative efforts for those skilled in the art.

FIG. 1 is a flowchart of a skin retouching and facial feature adjustment method according to an embodiment of the present disclosure.

FIG. 2 is a schematic diagram of a head network of an improved YOLOv7 model according to an embodiment of the present disclosure.

FIG. 3 is a schematic diagram of facial landmark positions according to an embodiment of the present disclosure.

FIG. 4 is a schematic diagram of deploying a skin retouching and facial feature adjustment method according to an embodiment of the present disclosure.

FIG. 5 is a block diagram of a skin retouching and facial feature adjustment apparatus according to an embodiment of the present disclosure.

FIG. 6 is a hardware structure diagram of a computer device according to an embodiment of the present disclosure.

### DETAILED DESCRIPTION

The technical solutions in the embodiments of the present disclosure will be clearly and completely described below with reference to the accompanying drawings in the embodiments of the present disclosure, and it is apparent that the described embodiments are only a part of the embodiments of the present disclosure rather than all of the embodiments. All other embodiments obtained by a person of ordinary skill in the art based on the embodiments of the present disclosure without creative efforts shall fall within the protection scope of the present disclosure.

The terms used in the embodiments of the present disclosure are for the purpose of describing specific embodiments only and are not intended to limit the embodiments of the present disclosure. The singular forms “a” and “the” used in the embodiments of the present disclosure and the appended claims are also intended to include plural forms, unless the context clearly indicates other meanings. It will also be understood that the term “and/or” as used herein refers to and encompasses any and all possible combinations of one or more of the associated listed items.

It should be understood that although terms such as first, second, and third may be used to describe various information in the embodiments of the present disclosure, the information should not be limited to these terms. These terms are only used to distinguish the same type of information from each other. For example, without departing from the scope of the embodiments of the present disclosure, first information may also be referred to as second information, and similarly, second information may also be referred to as first information. Depending on the context, the word “if” as used herein may be interpreted as “when” or “when” or “in response to determining”.

For purposes of brevity and ease of understanding, the terms used herein when characterizing magnitude relationships are “greater than” or “less than”, “higher than”, or “lower than”. However, for a person skilled in the art, it may be understood that the term “greater than” also covers a meaning of “greater than or equal to”, and “less than” also covers a meaning of “less than or equal to”; the term “higher than” covers a meaning of “higher than or equal to”, and “lower than” also covers a meaning of “lower than or equal to”.

In the related art, the skin retouching and facial feature adjustment algorithm usually recognizes a face bounding box of each person in an image, and performs operations of skin segmentation and landmark detection on an image region of the face bounding box, to perform skin retouching and facial feature adjustment processing. The inventor found that, people usually pay more attention to the skin retouching of the upper body region, but in the image region of the face bounding box, only the facial skin region can be recognized and segmented, and other skin regions (such as neck, shoulder) of the upper body in the image cannot be recognized and segmented, which results in the obvious difference between the facial skin region and other skin regions after the skin retouching and facial feature adjustment processing, leading to poor viewing experience. The inventor further found that, when the image region of the face bounding box includes other skin regions of the upper body other than the face, it results in excessive noise when recognizing facial landmarks in the image region of the face bounding box, leading to low detection accuracy and precision.

In view of the above technical problems, the present disclosure provides a skin retouching and facial feature adjustment method, in which the upper body bounding box and the face bounding box of the target person in the target image are recognized, and the image region of the upper body bounding box includes the facial skin region and other skin regions of the upper body, such that the facial skin region and other skin regions of the upper body are transitionally natural after the skin retouching, which improves the viewing experience, and the image region of the face bounding box only includes the face region, which greatly reduces the noise when recognizing facial landmarks in the image region of the face bounding box, and improves the detection accuracy and precision.

Details are described in detail by using one or more of the following embodiments.

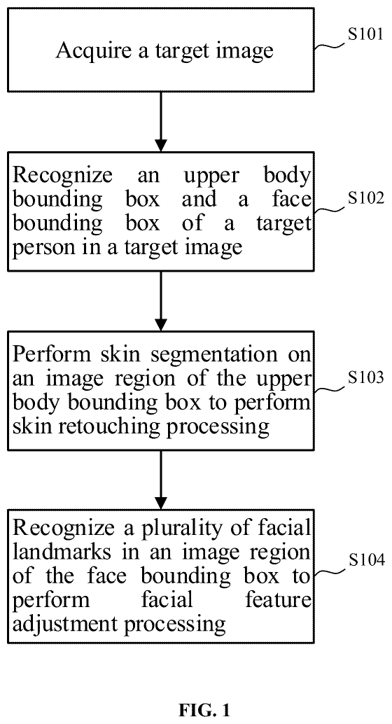

FIG. 1 is a flowchart of a skin retouching and facial feature adjustment method according to an embodiment of the present disclosure.

As illustrated in FIG. 1, the skin retouching and facial feature adjustment method may include the following steps.

At step S101: a target image is acquired.

At step S102: an upper body bounding box and a face bounding box of a target person in a target image are recognized.

At step S103: skin segmentation is performed on an image region of the upper body bounding box to perform skin retouching processing.

At step S104: a plurality of facial landmarks are recognized in an image region of the face bounding box to perform facial feature adjustment processing.

In the present embodiment, the upper body region of the target person may be determined through the upper body bounding box, and the upper body region may refer to a region formed above the chest, below the top of the head, and between the shoulders of the human body; the face region of the target person may be determined through the face bounding box, and the face region may refer to a region enclosed by a left ear boundary, a right ear boundary, a chin, and a forehead as boundaries, and is not necessary to include hair, so as to reduce noise when recognizing facial landmarks in the image region of the face bounding box.

In an embodiment, in step S102, recognizing the upper body bounding box and the face bounding box of the target person in the target image includes the steps described below.

At step S1021: preprocessing the target image is performed.

In the present disclosure, the preprocessing may include resolution adjustment, format conversion, and normalization on the target image, which is not limited in the present disclosure.

The resolution adjustment may be implemented based on an image scaling algorithm such as bilinear interpolation or bicubic interpolation, and an adjusted image resolution may be set according to actual situations, for example, may be set according to the requirement of an adopted target detection model for the size of an input image, or may be set according to actual application scenarios, for example, when the target detection model is deployed on a processor with weak performance, a resolution of a graph may be reduced, to reduce computational complexity, improve processing efficiency, and properly reduce the image resolution, which may balance image clarity and processing efficiency. The converted image format may be set according to a format requirement of the adopted target detection model for the input image, e.g., the input image may be converted into an RGB format, and then normalization may further be performed, e.g., a value of each pixel in the image is scaled to a specified range (e.g., [0,1]), so as to reduce computational complexity and improve processing efficiency.

At step S1022: a plurality of candidate upper body bounding boxes and a plurality of candidate face bounding boxes of the target person are recognized from the preprocessed target image based on a target detection model.

In this embodiment, the target detection model may include aYOLO model, an R-CNN model, and an SSD model, etc., which is not limited in the present disclosure.

In this embodiment, a target detection model may be adopted to perform recognition on a target image including several target persons, and for each target person, several candidate upper body bounding boxes for determining an upper body region of the target person and several candidate face bounding boxes for determining a face region of the target person may be recognized. The bounding box information may include the center coordinates, length, length, and width of the bounding box, which represent the size of the bounding box and the position of the bounding box in the target image, and the bounding box information may further include a confidence level, which represents a probability of the presence of a target within the bounding box.

The YOLOv7 model is a target detection model, a backbone network of the YOLOv7 model performs feature extraction on an input image, and outputs feature maps of different scales to the head network, and the head network fuses these feature maps to obtain a target detection result based on the fused feature maps.

For the YOLOv7 model, the present disclosure proposes a new multi-scale feature map fusion method, which performs two rounds of feature fusion on three types of feature maps with different scales. In each round, the scales of the feature maps being fused are different. For each feature fusion, the receptive field of the low-resolution feature map is enlarged, then, the processed low-resolution feature map is upsampled to increase the resolution of the processed low-resolution feature map, such that the increased resolution is equal to the resolution of the subsequent high-resolution feature map to be fused. Subsequently, a channel number of the upsampled feature map is adjusted to be the same as a channel number of the high-resolution feature map. Finally, the low-resolution feature map, which has undergone these series of processes, can be fused with the high-resolution feature map.

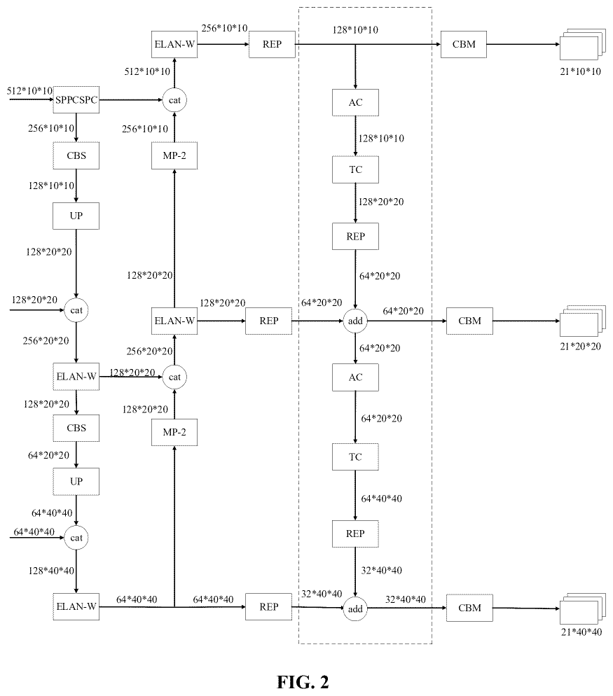

In an embodiment, the foregoing new multi-scale feature map fusion method may be embodied by an improved YOLOv7 model, as illustrated by a dashed box in FIG. 2, a head network of the improved YOLOv7 model includes a feature fusion module, and the feature fusion module may be configured to perform, on a low-resolution feature map, enlarging receptive fields, upsampling, and channel-number transformation, and then fuse the processed feature map with a high-resolution feature map.

Specifically, the feature fusion module may include several Atrous Convolution (AC) modules, several Transposed Convolution (TC) modules, several Reparameterization (REP) modules, and several add modules. The AC module may enlarge the receptive field by specifying the atrous convolution kemel with the dilation rate, such that the region on the input feature map corresponding to the pixel point of the feature map output in the subsequent processing process becomes larger, thereby improving the detection precision of the large target; the TC module may perform an upsampling operation on the input feature map to improve the resolution of the low-resolution feature map; the REP module may be configured to extract features ofthe feature map, perform feature fusion, and transform the channel number of the feature map; and the add module may fuse the processed low-resolution feature map and the high-resolution feature map through the add operation in the feature-fusion method, so as to perform feature map fusion at the next level based on the feature map obtained after the fusion and obtain the target detection result, and compared with the concat (concatenate) operation that only increases the quantity of features, the information amount of each feature in the feature map may be increased by using the add operation fusion, and the quantity of features remains unchanged, such that the position of the target in the image may be more accurately recognized, thereby improving the accuracy of the target detection. In addition, add operations require less computations and generate less data after fusion. In a scenario in which the neural network is deployed on a device with weak performance, e.g., in a live streaming scenario, the problem of low processing efficiency caused by an excessively large calculation amount may be avoided, which improves user experience.

The present embodiment provides an improved YOLOv7 model, in which a feature fusion module is added in a head network of the model to perform two rounds of feature fusion on three types of feature maps with different scales in a new multi-scale feature map fusion manner, and in the fusion manner, a feature fusion channel from low resolution to high resolution is newly added at a deep layer of the head network, such that the feature maps of different scales are further cross-fused, the depth of feature fusion is improved, the detection accuracy of a large target is further improved, and the amount of information of the fused feature map is richer, thereby further improving the detection precision of the large target while maintaining the detection precision of the YOLOv7 model for a small target, thereby greatly improving the target detection accuracy of the YOLOv7 model.

In an embodiment, several candidate upper body bounding boxes and several candidate face bounding boxes of the target person from the preprocessed target image may be recognized based on the improved YOLOv7 model.

Specifically, as illustrated in FIG. 2, the target image with the size of 320*320 is input into the improved YOLOv7 model, the backbone network performs feature extraction on the target image, and outputs feature maps with sizes of 512*10*10, 128*20*20, and 64*40*40 respectively to the head network; the head network first performs channel-number transformation and upsampling processing on the low-resolution feature map and then fuses the processed feature map with a high-resolution feature map, and then performs downsampling processing on the high-resolution feature map and then fuses the processed high-resolution feature map with a low-resolution feature map, to obtain feature maps with the sizes of 128*10*10, 64*20*20, and 32*40*40 respectively; and then performs two rounds of feature fusion on three types of feature maps with different scales by using a newly added feature fusion module, and then extracts features of the feature maps, performs feature fusion, and transforms the channel number of the feature maps through a CBM (Convolution-BatchNorm-Mish) module, to obtain several target detection result images with the sizes of 21*10*10, 21*20*20, and 21*40*40, respectively, where bounding boxes recognized in the target detection result image are classified into two types: an upper body bounding box and a face bounding box.

At step S1023: an upper body bounding box and a face bounding box are determined from the plurality of candidate upper body bounding boxes and the plurality of candidate face bounding boxes.

In this embodiment, for each target person, based on a Non-Maximum Suppression (NMS) algorithm, an upper body bounding box and a face bounding box may be determined from the plurality of candidate upper body bounding boxes and the plurality of candidate face bounding boxes corresponding to the target person.

In an embodiment, in step S103, performing skin segmentation on the image region of the upper body bounding box to perform skin retouching processing may include the steps described below.

At step S1031: an image region of the upper body bounding box is preprocessed.

In this embodiment, the image region of the upper body bounding box may be determined in the target image according to the center coordinates, length and width of the bounding box in the upper body bounding box information, so as to cut out an upper body image from the target image to perform preprocessing on the upper body image.

At step S1032: a skin probability distribution map and a non-skin probability distribution map are recognized from the preprocessed target image by the first neural network.

In this embodiment, the first neural network may be a neural network suitable for image segmentation such as DeepLab or U-Net, which is not limited in the present disclosure.

In this embodiment, the first neural network may be used to perform recognition on the target image, such that the probability that each pixel in the target image is in the target person's skin region may be determined to obtain the skin probability distribution map, and the probability that each pixel in the target image does not is in the target person's skin region may also be determined to obtain the non-skin probability distribution map.

At step S1033: a skin mask image of the target image based on the skin probability distribution map and the non-skin probability distribution map is determined.

In this embodiment, each pixel in the target image may be traversed, a probability value corresponding to the pixel in the skin probability distribution map may be compared with a probability value corresponding to the pixel in the non-skin probability distribution map, so as to determine whether the pixel is in the skin region, and then a set of pixels belonging to the skin region of the target person may be determined to obtain the skin mask image.

In an embodiment, the skin retouching and facial feature adjustment method may further include the steps described below.

At step S105: skin retouching processing on the target image is performed based on the skin mask image of the target image.

In this embodiment, skin retouching processing may be performed on the target image based on an image processing algorithm, specifically, a specific image processing algorithm may be selected according to actual skin retouching requirements, e.g., a 3D Lookup Table (3D LUT) algorithm may be used to achieve a whitening effect, and a Gaussian blur algorithm or a bilateral filtering algorithm may be used to achieve a skin smoothing effect, which is not limited in the present disclosure.

In an embodiment, in step S104, recognizing a plurality of facial landmarks in an image region of the face bounding box to perform facial feature adjustment processing may include the steps described below.

At step S1041: an image region of a face bounding box is preprocessed.

In this embodiment, the image region of the face bounding box may be determined in the target image according to the center coordinates, length, and width of the bounding box in the face bounding box information, so as to cut out the face image from the target image to perform preprocessing on the face image.

At step S1042: a plurality of candidate facial landmarks of the preprocessed target image are recognized by the second neural network.

In this embodiment, the second neural network may be a neural network suitable for landmark detection, such as MobileNet or ResNet, which is not limited in the present disclosure.

In this embodiment, different landmark regression methods based on the second neural network may be selected according to actual application scenarios, for example, a coordinate regression method may be adopted in a scenario with high real-time requirements, and a heat map regression method may be adopted in a scenario with high positioning accuracy of landmarks, which is not limited in the present disclosure.

At step S1043: a plurality of facial landmarks are determined from the plurality of candidate facial landmarks.

In a facial landmark recognition task, a plurality of landmarks located at a plurality of specified positions are usually defined on the face in advance, and the corresponding positions of the face in the images of the training set are labeled. In this embodiment, for each target person, based on the NMS algorithm, a facial landmark may be determined from several candidate facial landmarks corresponding to each specified position on the face of the target person, such that several facial landmarks corresponding to several specified positions may be determined.

The inventor found through research that, the landmarks of the nasal part in the standard 98 landmarks are located at the nose bridge and the boundary below the nose, and the recognition accuracy is low. Therefore, the inventor considers that customized landmarks may be added to the nasal region to improve the accuracy of nose recognition, such that the effect of thin nose may also be improved during the subsequent facial feature adjustment processing.

In an embodiment, the quantity of the facial landmarks is 106, 98 of the facial landmarks are standard landmarks, and 8 of the facial landmarks are customized landmarks located in a region of nose.

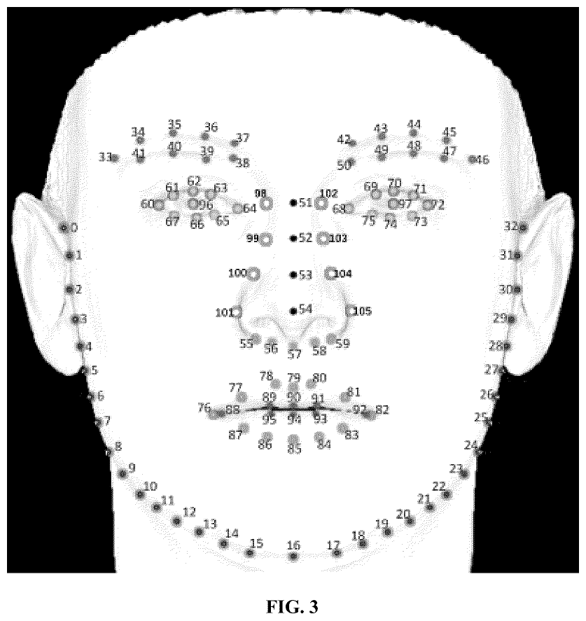

In this embodiment, the customized landmarks are symmetrically distributed on the left and right sides of the nose, and each customized landmark is intersected with a boundary of the nose through a horizontal line on the nose. As an example, as illustrated in FIG. 3, points 0-97 are standard landmarks, and points 98-105 are customized landmarks, where points 98-101 and points 102-105 are symmetrically distributed on the left and right sides of the nose, and are each a point where horizontal lines passing through points 51-54 intersect a boundary of the nose respectively.

In an embodiment, skin segmentation on an image region of the upper body bounding box is performed by a first neural network; recognizing a plurality of facial landmarks in an image region of the face bounding box is performed by a second neural network; and the first neural network and the second neural network are lightweight neural networks.

In this embodiment, considering that a neural network is deployed on a device with weak performance, e.g., being deployed on an embedded device in a live streaming scenario, a lightweight neural network is adopted, thereby avoiding the problem of low processing efficiency caused by high computational complexity, which improves user experience.

In an embodiment, a skin retouching and facial feature adjustment method may further include the steps described below.

At step S106: facial feature adjustment processing is performed on the target image based on a plurality of facial landmarks.

In this embodiment, the facial feature adjustment processing may be performed based on a deformation operation on the target image, specifically, deformation operations such as translation, scaling, or rotation may be performed on image content of a specified region (e.g., an eye region, a nose region, etc.) in the target image according to actual facial feature adjustment requirements, then coordinates of each pixel point after deformation may be computed to correspond to the coordinates of an original image, and an interpolation operation may be performed on the obtained coordinates of the original image to determine pixel values corresponding to the pixel points, where algorithms such as bilinear interpolation, bicubic interpolation, or nearest neighbor interpolation may be selected to perform the interpolation operation, which is not limited in the present disclosure.

The inventor found through research that, different deployment methods for the skin retouching and facial feature adjustment method also affects the overall processing efficiency of the method. Therefore, the inventor conceived the idea of deploying respective steps of the skin retouching and facial feature adjustment method on adapted processors, thereby further improving processing efficiency.

In an embodiment, a digital signal processor (DSP), a graphics processing unit (GPU), a neural network processing unit (NPU), and a central processing unit (CPU) may be deployed in a device that performs the foregoing skin retouching and facial feature adjustment method.

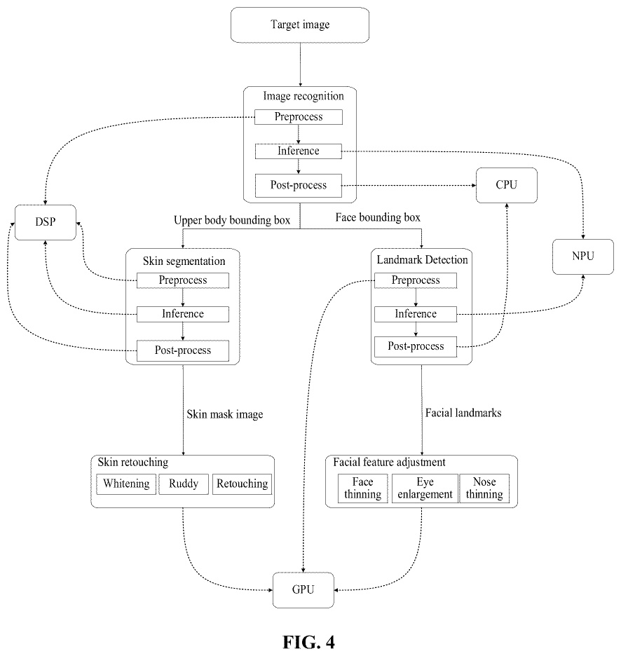

In this embodiment, referring to FIG. 4, the steps of the skin retouching and facial feature adjustment method may further include:
performing skin segmentation on an image region of an upper body bounding box through a DSP;
performing skin retouching processing and facial feature adjustment processing through a GPU;
the steps of recognizing an upper body bounding box and a face bounding box of a target person in a target image include:
preprocessing, through the DSP, the target image;
recognizing, through the NPU, a plurality of candidate upper body bounding boxes and a plurality of candidate face bounding boxes of the target person from the preprocessed target image based on a target detection model; and
determining, through the CPU, the upper body bounding box and the face bounding box from the plurality of candidate upper body bounding boxes and the plurality of candidate face bounding boxes.

The steps of recognizing a plurality of facial landmarks in the image region of the face bounding box includes:
preprocessing, through the GPU, an image region of the face bounding box;
recognizing, by the second neural network through the NPU, a plurality of candidate facial landmarks of the preprocessed target image; and
determining, through the CPU, a plurality of facial landmarks from the plurality of candidate facial landmarks.

In this embodiment, considering that the performance of the device performing the skin retouching and facial feature adjustment method is weak, e.g., the embedded device in a live streaming scenario, DSP and GPU are both suitable for image processing, where the power consumption of the DSP is small and the delay is low, which is more suitable for the scenario with high real-time requirements, therefore, the relevant steps of the image processing may be preferentially selected to be executed by the DSP.

Further, the inventor considers that both the DSP and the NPU are suitable for running a neural network, the CPU is suitable for performing a logical operation, the DSP is also suitable for performing a data-intensive operation with simple logic, and preprocessing of skin segmentation and preprocessing of landmark detection are mainly performing operations such as resolution adjustment, format conversion, or normalization on an image, which is each suitable for being deployed on the DSP and the GPU, post-processing of skin segmentation is mainly comparing a skin probability distribution map with a non-skin probability distribution map, which is suitable for being deployed on the DSP, and post-processing of landmark detection is mainly performing logical operations such as an NMS algorithm, which is suitable for being deployed on the CPU. In this way, the relevant steps for skin segmentation can be performed by the DSP.

In addition, the GPU performs the preprocessing step of landmark detection, the NPU performs the inference step of landmark detection, and the CPU performs the post-processing step of landmark detection, and the steps of skin segmentation and landmark detection are deployed on different processors respectively, thereby achieving an effect of performing the steps of skin segmentation and landmark detection in parallel, further shortening the processing time, and further improving processing efficiency, which may improve utilization of these processors on the device avoid the resource waste.

It should be noted that, the deployment method of the skin retouching and facial feature adjustment method of this embodiment may be adaptively adjusted according to the actual application scenarios, the installed or installable processor on the device, and the different characteristics of the adopted processors, which is not specifically limited in the present disclosure.

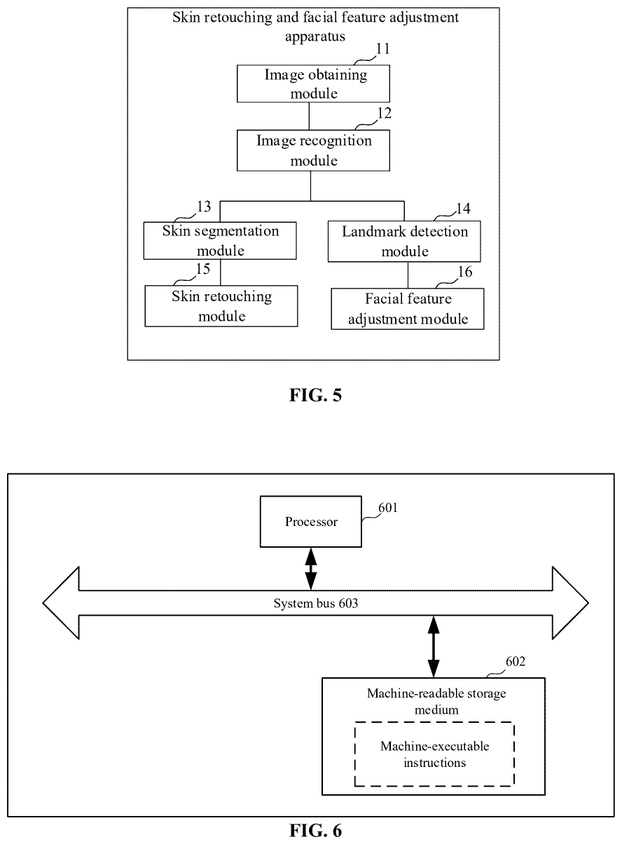

FIG. 5 is a block diagram of a skin retouching and facial feature adjustment apparatus according to an embodiment of the present disclosure, including:
an image obtaining module 11, configured to acquire a target image;
an image recognition module 12, configured to an upper body bounding box and a face bounding box of a target person in a target image;
a skin segmentation module 13, configured to perform skin segmentation on an image region of the upper body bounding box to perform skin retouching processing
a landmark detection module 14, configured to recognize a plurality of facial landmarks in an image region of the face bounding box to perform facial feature adjustment processing.

In an embodiment, the image recognition module 12 may include:
a first preprocessing module 120, configured to preprocess the target image.
a first inference module 121, configured to recognize a plurality of candidate upper body bounding boxes and a plurality of candidate face bounding boxes of the target person from the preprocessed target image based on a target detection model; and
a first post-processing module 122, configured to determine an upper body bounding box from the plurality of candidate upper body bounding boxes and determine a face bounding box from the plurality of candidate face bounding boxes.

In an embodiment, the skin segmentation module 13 may include:
a second preprocessing module 130, configured to preprocess an image region of the upper body bounding box;
a second inference module 131, configured to recognize, by the first neural network, a skin probability distribution map and a non-skin probability distribution map for the preprocessed target image; and
a second post-processing module 132, configured to determine a skin mask image of the target image based on the skin probability distribution map and the non-skin probability distribution map.

In an embodiment, the skin retouching and facial feature adjustment apparatus may further include:
a skin retouching module 15, configured to perform skin retouching processing on the target image based on the skin mask image of the target image.

In an embodiment, the landmark detection module 14 may include:
a third preprocessing module 140, configured to preprocess an image region of the face bounding box;
a third inference module 141, configured to recognize, by the second neural network, a plurality of candidate facial landmarks of the preprocessed target image; and
a third post-processing module 142, configured to determine a plurality of facial landmarks from the plurality of candidate facial landmarks.

In an embodiment, the skin retouching and facial feature adjustment may further include:
a facial feature adjustment module 16, configured to perform facial feature adjustment processing on the target image based on the plurality of facial landmarks.

In an embodiment, the quantity of the facial landmarks is 106, 98 of the facial landmarks are standard landmarks, and 8 of the facial landmarks are customized landmarks located in a region of nose.

In this embodiment, the customized landmarks are symmetrically distributed on the left and right sides of the nose, and each customized landmark is intersected with a boundary of the nose through a horizontal line on the nose. As an example, as illustrated in FIG. 3, points 0-97 are standard landmarks, and points 98-105 are customized landmarks, where points 98-101 and points 102-105 are symmetrically distributed on the left and right sides of the nose, and are each a point where horizontal lines passing through points 51-54 intersect a boundary of nose respectively.

FIG. 6 is a hardware structure diagram of a computer device according to an embodiment of the present disclosure. The computer device may include a processor 601 and a machine-readable storage medium 602 storing machine-executable instructions. The processor 601 and the machine-readable storage medium 602 may communicate via a system bus 603. In addition, by reading and executing the machine-executable instructions in the machine-readable storage medium 602 corresponding to the display logic of skin retouching and facial feature adjustment, the processor 601 may perform the skin retouching and facial feature adjustment method described above.

Machine-readable storage medium 602 referred to herein may be any electronic, magnetic, optical, or other physical storage device that may contain or store information such as executable instructions, data, and the like. For example, the machine-readable storage medium 602 may include at least one of the following storage mediums: a volatile memory, a non-volatile memory, and other types of storage mediums. The volatile memory may be a random access memory (RAM), and the non-volatile memory may be a flash memory, a storage drive (e.g., a hard disk drive), a solid-state drive, or a storage disc (e.g., an optical disc or a DVD, etc.).

Based on the method described in any one of the above embodiments, an embodiment of the present disclosure further provides a computer-readable storage medium, where a computer program is stored on the medium, and the computer program, when executed by at least one processor, implements the method described in any one of the above embodiments.

The system, apparatus, module, or unit illustrated in the above embodiments may be implemented specifically by at least one computer chip or entity, or by a product having a certain function. A typical implementation device is a computer, and a specific form of the computer may be a personal computer, a laptop computer, a cellular phone, a camera phone, a smartphone, a personal digital assistant, a media player, a navigation device, an email receiving and sending device, a game console, a tablet computer, a wearable device, or any combination of these devices.

It should also be noted that the terms “include,” “comprise” or any other variations thereof are intended to cover non-exclusive inclusion, such that a process, method, product or device including a series of elements includes not only those elements, but also other elements not explicitly listed, or elements inherent to such a process, method, product or device. An element proceeded by “comprises a . . . ” does not, without more constraints, preclude the existence of additional identical elements in the process, method, article, or device that comprises the element.

Specific embodiments of the present disclosure are described above. Other embodiments are within the scope of appended claims. In some cases, the actions or steps described in the claims may be performed in an order different from that in the embodiments and the desired results may still be achieved. In addition, the processes depicted in the accompanying figures do not necessarily require the illustrated particular order, or sequential order, to achieve desirable results. In certain implementations, multitasking and parallel processing may also be advantageous.

The description of “specific examples,” “some examples” or the like means that specific features, structures, materials or characteristics described in conjunction with the embodiments or examples are included in at least one embodiment or example of the present disclosure. In the present disclosure, the schematic representation of the above terms does not necessarily refer to the same embodiment or example. Furthermore, the particular features, structures, materials, or characteristics may be combined in any suitable manner in any one or more embodiments or examples.

Other embodiments of the present disclosure will be apparent to those skilled in the art from consideration of the specification and practice of the present disclosure disclosed here. This disclosure is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It should be understood that the present disclosure is not limited to the precise structures described above and illustrated in the accompanying drawings, and various modifications and changes may be made without departing from the scope thereof. The scope of the present disclosure is limited only by the appended claims.

The above description is embodiments of the present disclosure and is not intended to limit the present disclosure, and any modifications, equivalent substitutions, improvements and the like made within the spirit and principle of the present disclosure should be included within the scope of protection of the present disclosure.

1. A skin retouching and facial feature adjustment method, comprising:
acquiring a target image;
recognizing an upper body bounding box and a face bounding box of a target person in a target image;
performing skin segmentation on an image region of the upper body bounding box to perform skin retouching processing; and
recognizing a plurality of facial landmarks in an image region of the face bounding box to perform facial feature adjustment processing.

2. The method according to claim 1, wherein a quantity of the facial landmarks is 106, 98 of the facial landmarks are standard landmarks, and 8 of the facial landmarks are customized landmarks in a region of a nose.

3. The method according to claim 2, wherein the customized landmarks are symmetrically distributed on left and right sides of the nose, and each customized landmark is intersected with a boundary of the nose through a horizontal line on the nose.

4. The method according to claim 1, wherein skin segmentation on the image region of the upper body bounding box is performed by a first neural network; recognizing the plurality of facial landmarks in the image region of the face bounding box is performed by a second neural network; and the first neural network and the second neural network are lightweight neural networks.

5. The method according to claim 4, wherein a device performing the method is deployed with a digital signal processor (DSP), a graphics processing unit (GPU), a neural network processing unit (NPU), and a central processing unit (CPU), and the method further comprises:
performing, through the DSP, skin segmentation on the image region of the upper body bounding box;
performing, through the GPU, skin retouching processing and performing facial feature adjustment processing;
recognizing the upper body bounding box and the face bounding box of the target person in the target image comprises:
preprocessing, through the DSP, the target image;
recognizing, through the NPU, a plurality of candidate upper body bounding boxes and a plurality of candidate face bounding boxes of the target person from the preprocessed target image based on a target detection model; and
determining, through the CPU, the upper body bounding box and the face bounding box from the plurality of candidate upper body bounding boxes and the plurality of candidate face bounding boxes; and
recognizing the plurality of facial landmarks in the image region of the face bounding box comprises:
preprocessing, through the GPU, the image region of the face bounding box;
recognizing, by the second neural network through the NPU, a plurality of candidate facial landmarks of the preprocessed target image; and
determining, through the CPU, the plurality of facial landmarks from the plurality of candidate facial landmarks.

6. The method according to claim 5, wherein the target detection model is an improved YOLOv7 model, a head network of the improved YOLOv7 model is configured to perform, on a low-resolution feature map, enlarging receptive fields, upsampling, and channel-number transformation, and fuse the processed low-resolution feature map with a high-resolution feature map.

7.-8. (canceled)

9. A computer device, comprising at least one processor and a machine-readable storage medium, wherein the machine-readable storage medium stores machine-executable instructions executable by the at least one processor, and the at least one processor is enabled by the machine-executable instructions to perform operations comprising:
acquiring a target image:
recognizing an upper body bounding box and a face bounding box of a target person in a target image;
performing skin segmentation on an image region of the upper body bounding box to perform skin retouching processing; and
recognizing a plurality of facial landmarks in an image region of the face bounding box to perform facial feature adjustment processing.

10. A non-transitory computer-readable storage medium, wherein the medium stores a computer program, and the computer program, when executed by at least one processor, implements operations comprising:
acquiring a target image;
recognizing an upper body bounding box and a face bounding box of a target person in a target image:
performing skin segmentation on an image region of the upper body bounding box to perform skin retouching processing; and
recognizing a plurality of facial landmarks in an image region of the face bounding box to perform facial feature adjustment processing.

11. The computer device according to claim 9, wherein a quantity of the facial landmarks is 106, 98 of the facial landmarks are standard landmarks, and 8 of the facial landmarks are customized landmarks in a region of a nose.

12. The computer device according to claim 11, wherein the customized landmarks are symmetrically distributed on left and right sides of the nose, and each customized landmark is intersected with a boundary of the nose through a horizontal line on the nose.

13. The computer device according to claim 9, wherein skin segmentation on the image region of the upper body bounding box is performed by a first neural network; recognizing the plurality of facial landmarks in the image region of the face bounding box is performed by a second neural network; and the first neural network and the second neural network are lightweight neural networks.

14. The computer device according to claim 13, wherein the computer device is deployed with a digital signal processor (DSP), a graphics processing unit (GPU), a neural network processing unit (NPU), and a central processing unit (CPU), and the operations further comprising:
performing, through the DSP, skin segmentation on the image region of the upper body bounding box;
performing, through the GPU, skin retouching processing and performing facial feature adjustment processing;
recognizing the upper body bounding box and the face bounding box of the target person in the target image comprises:
preprocessing, through the DSP, the target image;
recognizing, through the NPU, a plurality of candidate upper body bounding boxes and a plurality of candidate face bounding boxes of the target person from the preprocessed target image based on a target detection model; and
determining, through the CPU, the upper body bounding box and the face bounding box from the plurality of candidate upper body bounding boxes and the plurality of candidate face bounding boxes; and
recognizing the plurality of facial landmarks in the image region of the face bounding box comprises:
preprocessing, through the GPU, the image region of the face bounding box;
recognizing, by the second neural network through the NPU, a plurality of candidate facial landmarks of the preprocessed target image; and
determining, through the CPU, the plurality of facial landmarks from the plurality of candidate facial landmarks.

15. The computer device according to claim 14, wherein the target detection model is an improved YOLOv7 model, a head network of the improved YOLOv7 model is configured to perform, on a low-resolution feature map, enlarging receptive fields, upsampling, and channel-number transformation, and fuse the processed low-resolution feature map with a high-resolution feature map.

16. The non-transitory computer-readable storage medium according to claim 10, wherein a quantity of the facial landmarks is 106, 98 of the facial landmarks are standard landmarks, and 8 of the facial landmarks are customized landmarks in a region of a nose.

17. The non-transitory computer-readable storage medium according to claim 16, wherein the customized landmarks are symmetrically distributed on left and right sides of the nose, and each customized landmark is intersected with a boundary of the nose through a horizontal line on the nose.

18. The non-transitory computer-readable storage medium according to claim 10, wherein skin segmentation on the image region of the upper body bounding box is performed by a first neural network; recognizing the plurality of facial landmarks in the image region of the face bounding box is performed by a second neural network; and the first neural network and the second neural network are lightweight neural networks.

19. The non-transitory computer-readable storage medium according to claim 18, wherein the at least one processor comprises a digital signal processor (DSP), a graphics processing unit (GPU), a neural network processing unit (NPU), and a central processing unit (CPU), and the operations further comprises:
performing, through the DSP, skin segmentation on the image region of the upper body bounding box;
performing, through the GPU, skin retouching processing and performing facial feature adjustment processing;
recognizing the upper body bounding box and the face bounding box of the target person in the target image comprises:
preprocessing, through the DSP, the target image;
recognizing, through the NPU, a plurality of candidate upper body bounding boxes and a plurality of candidate face bounding boxes of the target person from the preprocessed target image based on a target detection model; and
determining, through the CPU, the upper body bounding box and the face bounding box from the plurality of candidate upper body bounding boxes and the plurality of candidate face bounding boxes; and
recognizing the plurality of facial landmarks in the image region of the face bounding box comprises:
preprocessing, through the GPU, the image region of the face bounding box;
recognizing, by the second neural network through the NPU, a plurality of candidate facial landmarks of the preprocessed target image; and
determining, through the CPU, the plurality of facial landmarks from the plurality of candidate facial landmarks.

20. The non-transitory computer-readable storage medium according to claim 19, wherein the target detection model is an improved YOLOv7 model, a head network of the improved YOLOv7 model is configured to perform, on a low-resolution feature map, enlarging receptive fields, upsampling, and channel-number transformation, and fuse the processed low-resolution feature map with a high-resolution feature map.
